(19) United States
(12) Patent Application Publication
(10) Pub. No.: US 2017/0021675 A1
(43) Pub. Date: Jan. 26, 2017

(54) METHOD FOR FORMING A TIRE HAVING A ZERO THICKNESS SIPE AND TIRE OBTAINED THEREBY

(71) Applicants: Sadi KOSE, Greer, SC (US); Robert LAWSON, Pelzer, SC (US)

(72) Inventors: Sadi KOSE, Greer, SC (US); Robert LAWSON, Pelzer, SC (US)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 15/039,301

(22) PCT Filed: Jul. 18, 2014
(86) PCT No.: PCT/US2014/047262

§ 371 Date: May 25, 2016

Related U.S. Application Data
(60) Provisional application No. 61/909,363, filed on Nov. 26, 2013.

(51) Int. Cl. B60C 11/12; B29D 30/06; B29C 43/02

(52) U.S. Cl. CPC B60C 11/1281; B29C 43/021; B29D 30/0662; B60C 11/1236; B60C 11/1204; B29C 2043/023; B29L 2030/00

(57) ABSTRACT

A method of forming a tire that includes providing a mold configured to mold a tire tread and having a sipe-forming element, spaced apart inwardly from an outermost molding surface, that includes a knife edge oriented towards the outermost molding surface and a submerged void-forming portion extending from the knife edge, arranging an uncured tire tread within the mold, molding the tire tread arranged within the mold, and demolding the tire tread from the mold such that the sipe-forming element forms a sipe by the knife edge (48) lacerating a thickness of the tire tread as the sipe-forming element is pulled in a direction toward the outermost molding surface and forms a submerged void arranged below the sipe within the tire tread. A tire including a sipe (30) and a submerged void (32) as described above is also disclosed.

This application claims priority to, and the benefit of, U.S. Provisional Patent Application No. 61/909,363 filed on Nov. 26, 2013 with the United States Patent Office, which is hereby incorporated by reference.

### BACKGROUND OF THE INVENTION

Field of the Invention

This invention relates generally to methods and apparatus for forming essentially zero-thickness sipes (also referred to herein more simply as “zero-thickness sipes”), and treads and tires having zero-thickness sipes.

Description of the Related Art

Tire treads are known to include a pattern of voids and such arranged along a ground-engaging side of the tread to provide sufficient traction and handling during particular conditions. For example, grooves provide void into which water, mud, or other environmental materials may be diverted to better allow the tread surface to engage a ground surface. It is also known to use sipes to create edges along the ground-engaging surface of the tread, which improve traction when operating in wet, snowy, or icy conditions. Commonly, sipes are formed by molding a narrow slot or groove into the tread. With the presence of void within a sipe, the stiffness of the tread may decrease, which may also reduce the tire traction and handling. Therefore, there is a desire to form zero-thickness sipes by reducing or generally eliminating the concurrent formation of void within the sipe. Also, it is desirous to form sipes without generating much or any additional void along the ground engaging side, as the addition of void reduces the amount of ground-engaging tread surface (also referred to as “contact surface”) available for contacting the ground during tire operation. When reducing the amount of contact surface available, wear performance may also decrease.

### SUMMARY OF THE INVENTION

Particular embodiments of the invention include a method of forming a tire. The method can include providing a mold configured to mold a tire tread, the mold having an outermost molding surface configured to form a ground-engaging side or surface of the tire tread and a sipe-forming element spaced apart inwardly from the outermost molding surface and having a knife edge oriented towards the outermost molding surface and a submerged void-forming portion extending from the knife edge, the sipe-forming element having a length extending in a direction transverse to the tread thickness. Particular embodiments of the method can also include arranging an uncured tire tread within the mold, the tire tread having a thickness extending depthwise into the molding cavity from the outermost molding surface such that a portion of the tire tread is arranged between the outermost molding surface and the sipe-forming element. The method can also include molding the tire tread arranged within the mold to form a cured molded tread having a thickness extending from a ground-engaging side of the cured molded tread. Further, in embodiments, the method can include demolding the tire tread from the mold such that the sipe-forming element forms a sipe by the knife edge lacerating a thickness of the cured molded tread as the sipe-forming element is pulled in a direction toward the outermost molding surface and forms a submerged void spaced below the ground-engaging side and arranged below the sipe within the thickness of the cured molded tread, the sipe having a length extending in a direction transverse to the tread thickness. It follows that particular embodiments of the invention comprises a molded tire formed by any of the methods recited above, or otherwise herein.

Particular embodiments of the present invention also include a tire. The tire can include a pair of sidewalls extending radially outward to a central portion of the tire, the pair of sidewalls being spaced apart in an axial direction of the tire. The tire can further include a tire tread extending between the pair of sidewalls, the tire tread having a thickness extending from a ground-engaging side or surface to a bottom side interfacing the central portion of the tire. In particular embodiments, the tire can include a sipe having length extending in a direction traverse to the tread thickness, a zero width extending transverse to the length and into a depth of the tread thickness from the ground-engaging side. Further, in embodiments, the tire can include a submerged void spaced below the ground-engaging side and arranged below the sipe within the thickness of the tire tread.

### DETAILED DESCRIPTION OF THE DRAWINGS

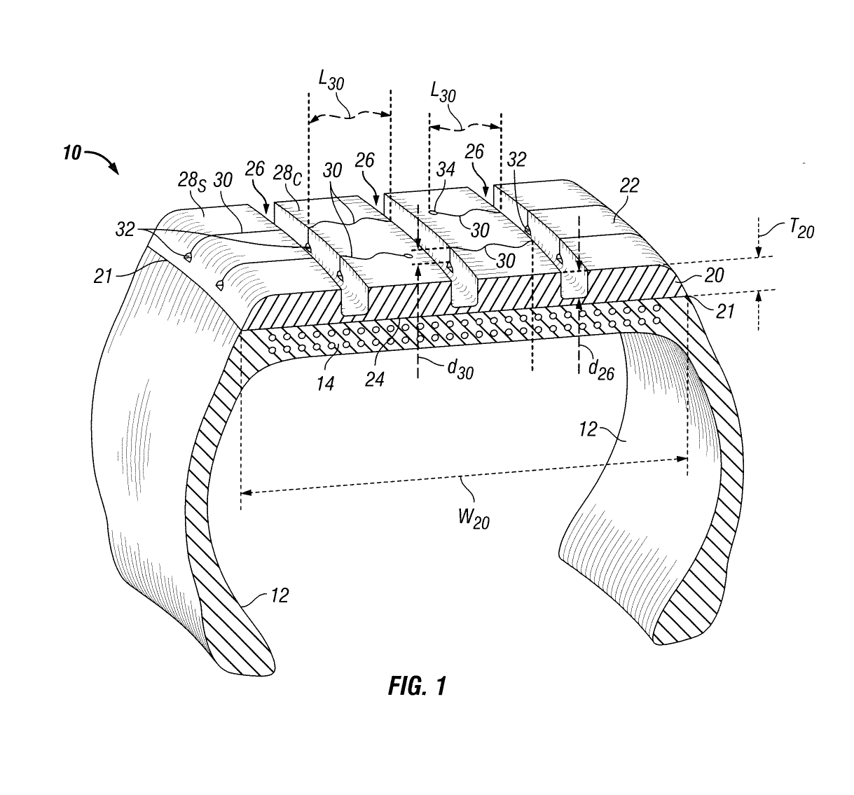

FIG. 1 is a perspective, partial cutaway view of a tire, in accordance with an embodiment.

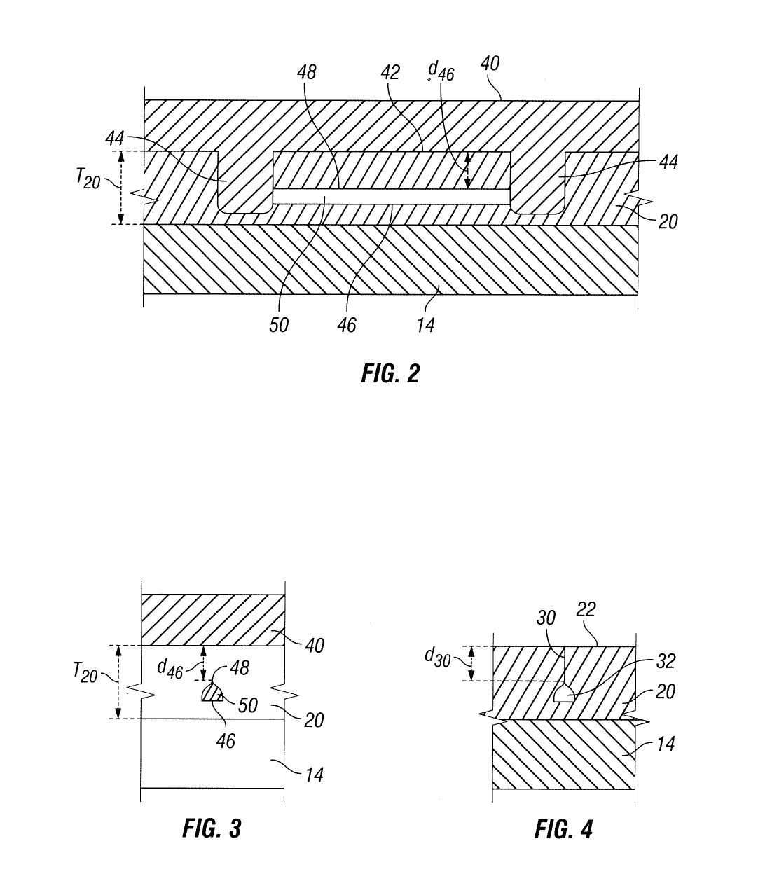

FIG. 2 is a side, partial cutaway, view of a tire tread arranged in a mold including a sipe-forming element for forming a zero-thickness sipe, in accordance with an embodiment.

FIG. 3 is a cross-sectional view of the tire tread arranged in the mold of FIG. 2, in accordance with an embodiment.

FIG. 4 is a cross-sectional view of the tire tread after demolding, in accordance with an embodiment.

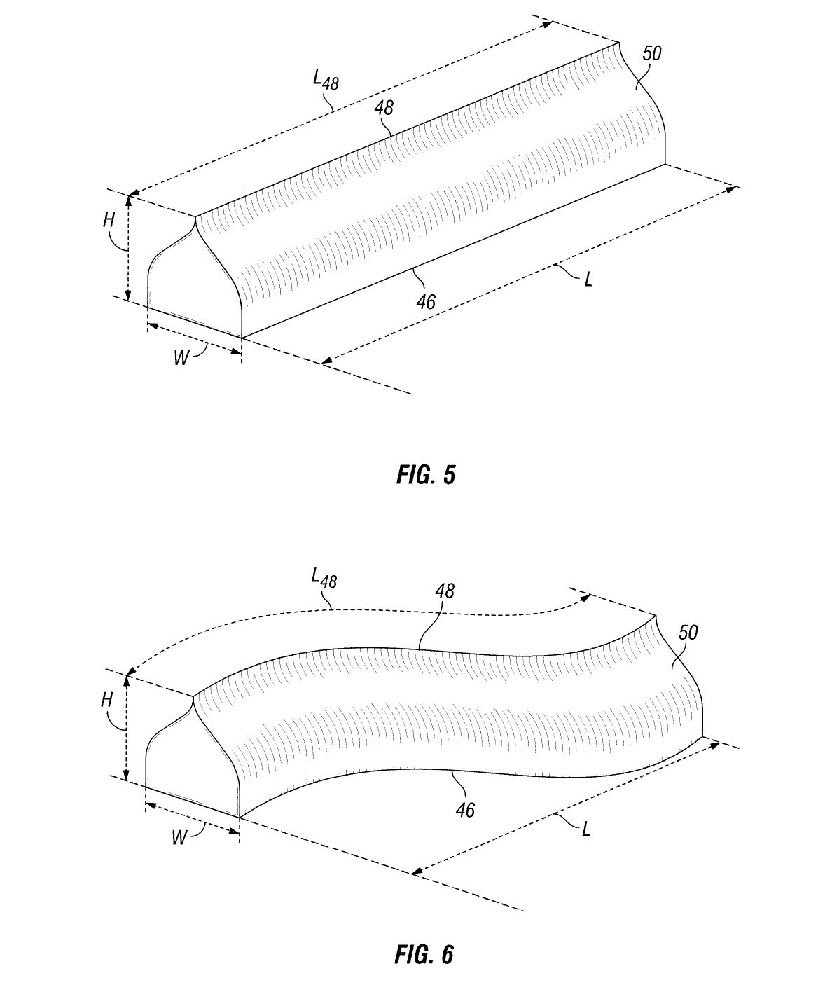

FIG. 5 is a perspective view of a sipe-forming element configured to form a zero-thickness sipe and a teardrop-shaped submerged groove.

FIG. 6 is a perspective view of a sipe-forming element configured to form an undulating zero-thickness sipe and a teardrop-shaped submerged groove.

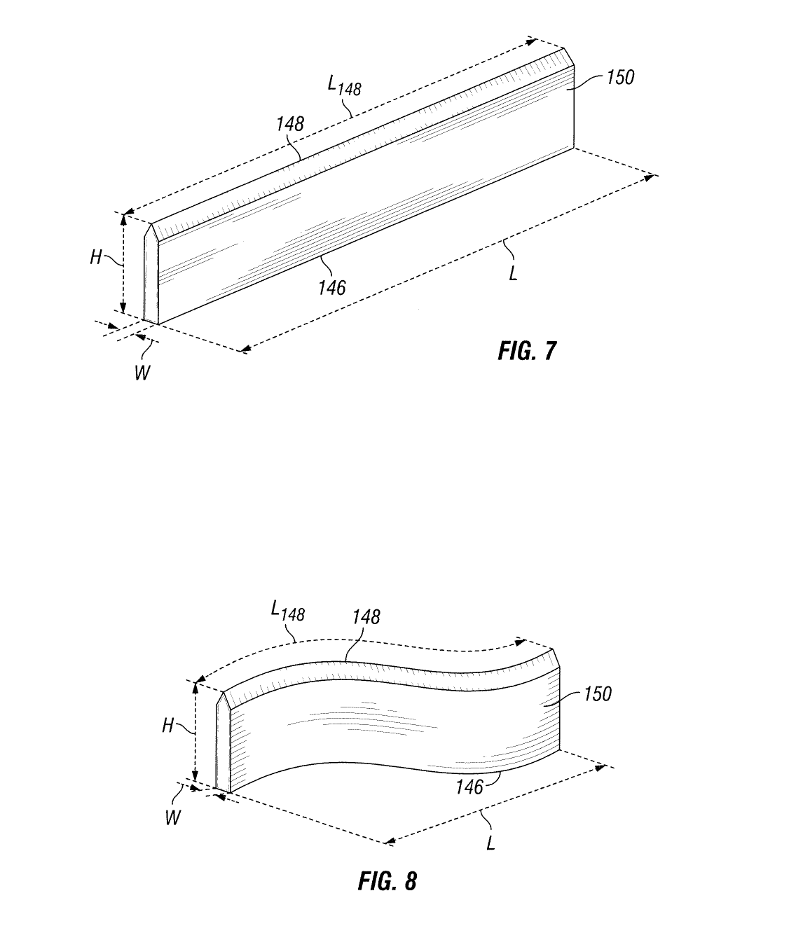

FIG. 7 is a perspective view of a sipe-forming element configured to form a zero-thickness sipe and a narrow submerged groove.

FIG. 8 is a perspective view of a sipe-forming element configured to form an undulating zero-thickness sipe and a narrow submerged groove.

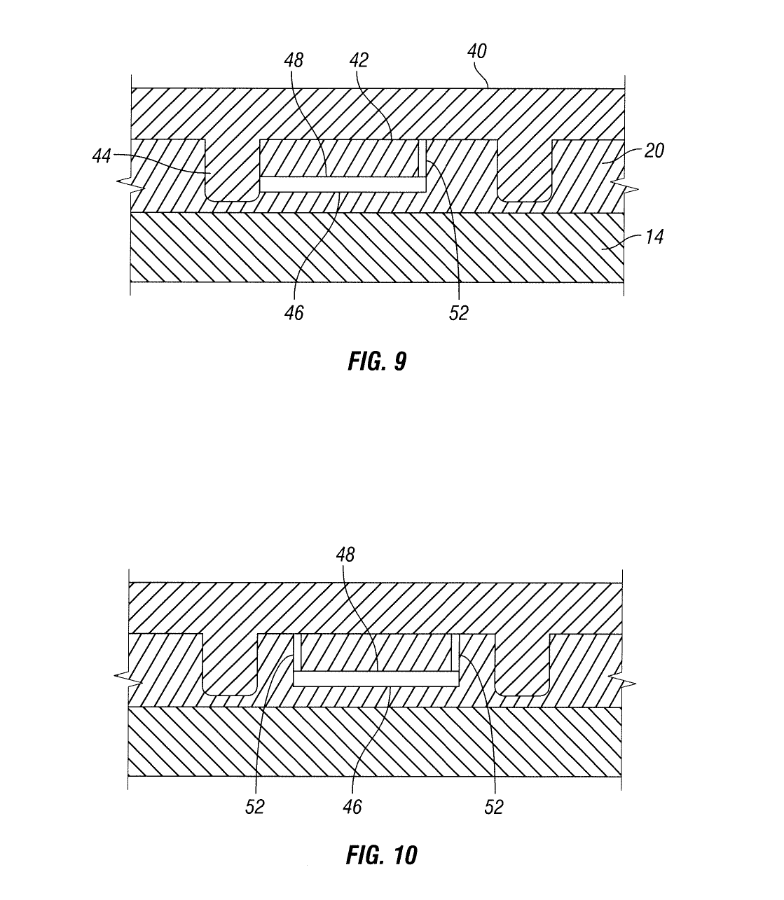

FIG. 9 is a side, partial cutaway view of a tire tread arranged in a mold including a sipe-forming element cantilevered from a groove-forming element, in accordance with an alternative embodiment.

FIG. 10 is a side, partial cutaway view of a tire tread arranged in a mold including a sipe-forming element spaced apart from groove-forming elements and anchored to a molding surface, in accordance with an alternative embodiment.

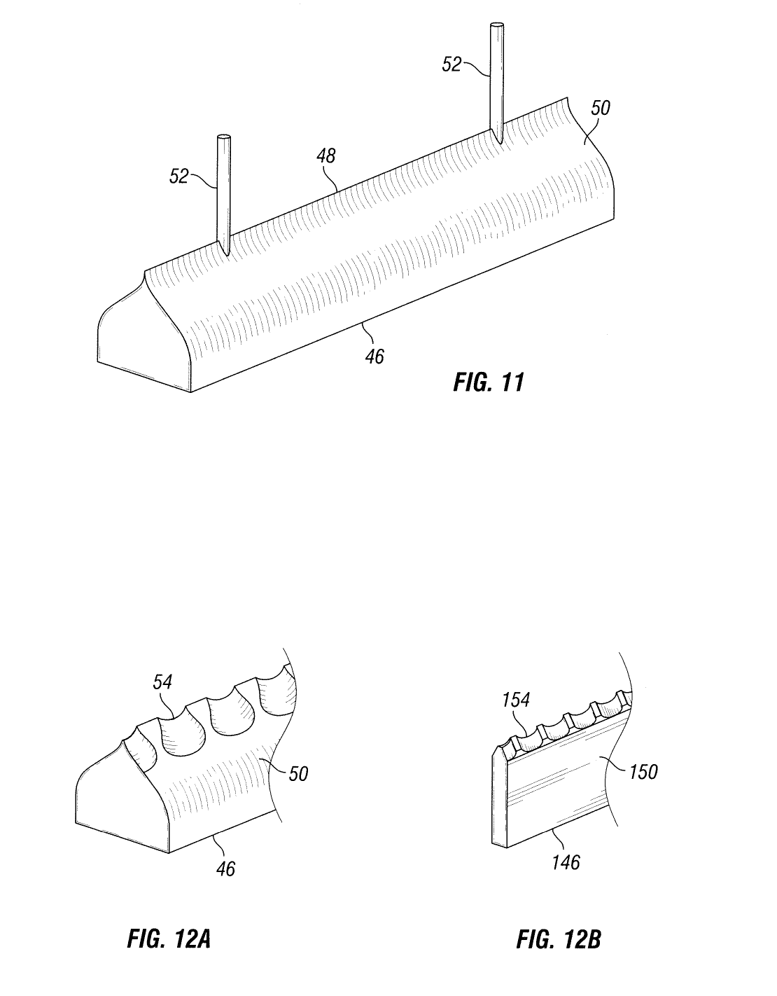

FIG. 11 is a perspective view of a sipe-forming element of FIG. 10, in accordance with an embodiment.

FIG. 12A is a partial perspective view of a sipe-forming element having a serrated or jagged edge, in accordance with an embodiment.

FIG. 12B is a partial perspective view of a sipe-forming element having a serrated or jagged edge, in accordance with another embodiment.

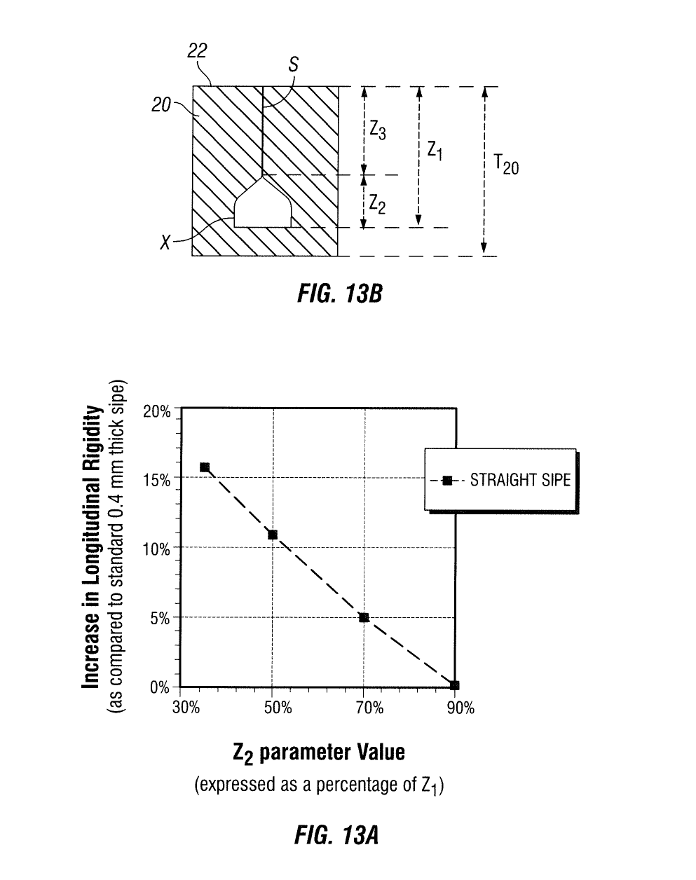

FIG. 13A is a chart showing the results of a simulation performed, where tire treads having straight zero-thickness sipes show an increase in transverse rigidity relative to tire treads having standard sipes.

FIG. 13B is a diagram of a tread thickness cross-section showing various parameters, as referenced in the chart of FIG. 13A, describing the location and size of a sipe and a submerged void arranged within a tread thickness, in accordance with a particular embodiment of the invention.

### DETAILED DESCRIPTION OF PARTICULAR EMBODIMENTS

Particular embodiments of the invention provide a tire including zero-thickness sipes (also referred to as “lamelles”), tire molds and methods for forming such sipes, as well as treads and tires having such treads having substantially zero-thickness sipes (also referred to herein more simply as “zero-thickness sipes”).

Disclosed in this application a method of forming a tire tread or tire having a tire tread, each of which include one or more sipes each comprising a laceration or slice extending through a thickness of the tire tread.

In particular embodiments, such methods include a step of providing a mold having a molding cavity configured to mold a tire tread. The mold may comprise a tire mold, which is configured to receive a tire having a tire tread for molding, or only a tire tread, such as when forming a tread for later application to a tire carcass in retreading operations, for example. Any such mold generally has an annular molding cavity, and may comprise any type of mold, such as a clamshell mold or a segmented mold, for example. In any event, any such mold includes a molding cavity defined at least in part by an outermost molding surface configured to form a ground-engaging side of the tire tread. The outermost molding surface can also be referred to as the ground-engaging molding surface or portion of the mold or molding cavity. The outermost molding surface is arranged along an outer cavity side, which is generally annular or circumferential in shape. Therefore, when relating any feature of the mold or tire tread to the outermost molding surface, the same relation can be made or drawn relative to the outer cavity side by substituting the outer cavity side for the outermost molding surface. Any such mold also includes a pair of opposing shoulder-molding portions configured to form a pair of opposing shoulders of the tire tread, the outermost molding surface being arranged between the pair of opposing shoulder-molding portions. It can also be said that the pair of opposing shoulders are spaced apart and arranged on opposing lateral sides of the tread width.

Any such mold further includes a sipe-forming element spaced apart inwardly from the outermost molding surface, or, in other words, in an inward direction of the cavity from the outermost molding surface. By doing so, an area is formed between the outermost molding surface and the sipe-forming element for receiving tread material. The sipe-forming element includes a knife edge oriented towards the outermost surface of the mold, or, in other words, on a side of the sipe-forming element facing the outermost surface of the mold. The knife edge may be sufficiently sharp, that is, as sharp as needed to lacerate or slice a thickness of the tread. A laceration or slice is also referred to as a discontinuity. Moreover, to facilitate extraction, the knife edge can be serrated or otherwise have a jagged-edge.

The sipe-forming element also has knife edge having a length extending in a direction transverse to the tread thickness and along a path. By extending along a path, the knife edge of the sipe-forming element is able to form a sipe having a length extending along a path along the ground-engaging side of the tread. By providing a non-linear extension of the sipe length, the local stiffness or rigidity of the tread is increased in a direction transverse to a direction of the sipe height or depth or to a direction of the tread thickness. This may further reclaim the loss in rigidity that naturally occurs when forming a sipe within the tread. It is noted that the path can be a linear path or a non-linear path. A non-linear path may be, for example, an undulating path (i.e., a zig-zag path) having a plurality of peaks and valleys (that is, apexes and troughs), such as a sinusoidal or a saw-tooth path, for example. Therefore, it is contemplated that the non-linear path may be curvilinear or comprise a plurality of linear segments, or any combination thereof.

In particular embodiments, the mold further includes a groove-forming element (more generally referred to herein as a submerged void-forming element, which may substituted for any groove-forming element in any embodiment discussed herein) extending inward from the outermost molding surface, or in other words, into the molding cavity from the outermost molding surface. It is appreciated that any mold may comprise one or more (“one or a plurality of”) groove-forming elements. In an example where the mold cavity is substantially annular, it can be said that the groove-forming element extends radially inward from the outermost molding surface.

It is appreciated that any sipe-forming element may be operably attached to the mold in any manner sufficient to maintain the sipe-forming element in an arrangement spaced-apart from the outermost molding surface of the mold. For example, when the mold includes a groove-forming element, in particular embodiments, the sipe-forming element is operably attached to the groove-forming element. It is appreciated that the sipe-forming element may be attached in any desired arrangement to the groove-forming element in an arrangement spaced-apart from the outer most molding surface. For example, the sipe-forming element may be cantilevered from the groove-forming element, such as when a sipe to be formed by the sipe-forming element is to be spaced apart from a groove formed by a second groove-forming member, for example. By further example, the sipe-forming element may be arranged to extend from a plurality of groove-forming elements, such as when a sipe is to be formed extending between a pair of grooves. The same sipe-forming element may continue on and extend to attach to yet another groove-forming element.

In is also appreciated that, in particular embodiments, the sipe-forming element is spaced apart from the groove-forming element. This may be achieved by any manner, such as by cantilevering the sipe-forming element from another or second groove-forming element, whereby the sipe-forming element extends towards the (first) groove-forming element such that a terminal end of the sipe-forming element is spaced apart from the (first) groove-forming element. This may also be achieved by attaching the sipe-forming element to the outermost surface or outer side of the mold cavity. In particular arrangements, the sipe-forming element is spaced apart from, and arranged between, the groove-forming element and a second groove-forming element. To rigidly maintain the sipe-forming element in a desired position, a support element or a plurality of support elements extend between the sipe-molding element and the outermost molding surface or the outer side of the molding cavity are provided. In being attached, it is appreciated that the sipe-forming element may be removably or permanently attached to the groove-forming element. It is also appreciated that the sipe-forming element may be formed integral with the groove-forming element or monolithic with the sipe-forming element. In accordance with the foregoing examples, it is to be appreciated that the sipe-forming element generally extends along the path, be it a linear or non-linear path, in a direction substantially transverse to a direction of a length of the groove-forming element.

Additional embodiments of the method include a step of arranging an uncured tire tread within the mold. The uncured tire tread includes a thickness extending depthwise from an outer side (i.e., from the outermost molding surface) such that a portion of the tire tread is arranged between the outermost molding surface and the sipe-forming element. That is, a gap exists between the sipe-forming element and the outermost molding surface to enable tread material to flow there between. After arranging the uncured tire tread within the mold, embodiments of the method include a step of molding the tire tread to form a cured molded tread having a thickness extending from a ground-engaging side of the tread. The ground-engaging side is also referred to as a top side, an outer side, or an exterior side of the tread. The ground-engaging side also includes at least one ground-engaging surface. Accordingly, when referencing a ground-engaging side of the tread, such as when describing the tread thickness or the location of a sipe or void, a ground-engaging surface may be substituted for the ground-engaging side for reference purposes. The cured molded tread also includes a pair of opposing shoulders extending along the lateral sides of the tread width in a direction of the tread thickness. As mentioned elsewhere herein, the tire tread may be molded alone (that is, separately from the tire) or while attached to a tire. During the molding process, the tread is cured, as the tread is generally formed of a curable elastomeric material, such as natural or synthetic rubber or any other polymeric material.

As a result of the step of molding, the tire tread includes a tread pattern, which is a predetermined arrangement of voids to provide a particular volumetric void ratio, surface void ratio, and layout of void and contact surfaces along a width and length of the tread. Volumetric void ratio is the ratio of volumetric void available at a particular worn depth of the tread relative to the total volume of the tread at the particular worn depth—where the total volume includes both void and tread material available. Surface void ratio is the ratio of surface void arranged along the outer side, or ground-engaging side, of the tread at a particular worn depth of the tread relative to the total surface area available of the tread at the particular worn depth—where the total area includes both void and tread areas arranged along the outer side.

As used in this application, the term “discontinuity” comprises any void, such as a groove or traditional sipe having a thickness or width substantially greater than zero, or any laceration, such as a zero-thickness sipe discussed herein, where any such discontinuity has a depth extending into the tread thickness. A void may be arranged along the ground-engaging side of the tread, or offset below the ground-engaging side of the tread to form a submerged void within the tread thickness. It is appreciated that a discontinuity may have a length extending in any direction transverse to the tread thickness, such as in a direction of the tread length and/or width. For example, the sipe or groove may be a longitudinal or lateral sipe or groove. Longitudinal grooves or sipe generally extend in a direction of the tread length, which may extend circumferentially around the tire. It is also contemplated that a longitudinal groove or sipe may extend at an angle biased to a circumferential direction of the tire. Lateral grooves or sipes generally extend in a direction of the tread width, where the lateral groove or sipe generally extends in a direction perpendicular to a longitudinal centerline of the tread (which extends in a direction of the tread length) or at an angle biased to the longitudinal centerline. It is appreciated that the length of any discontinuity may extend along any linear or non-linear path as desired, where a non-linear path is more fully described herein. Moreover, unless otherwise specified herein, any groove discussed herein may comprise a lateral or longitudinal groove and any sipe, whether or not a zero-thickness sipe, may comprise a lateral or longitudinal sipe. Accordingly, unless otherwise specified, a groove-forming element may be a longitudinal or lateral groove-forming element, which is configured to form a longitudinal or lateral groove, respectively. Likewise, unless otherwise specified, a sipe-forming element may be a longitudinal or lateral sipe-forming element, which is configured to form a longitudinal or lateral sipe, respectively.

With particular regard to the zero-thickness sipe, such sipe is a discontinuity comprising a laceration or slice extending through a thickness of the tread to define a depth or height of the sipe, the sipe having a length extending in a direction transverse to a thickness of the tread and a width or thickness extending transverse to both the length and depth of the sipe. Because the sipe is a laceration, the width or thickness of the sipe is substantially zero, as no material is being removed to form the sipe in the tread. Moreover, the sipe is formed such that the sipe is in a substantially zero-thickness arrangement when the tread is arranged annularly around the tire, where the sipe is in closed arrangement and appears as a slit or slice along the ground-engaging surface of the tread. In other words, when the tire tread is generally in an undeformed arrangement, the sipe is in a closed arrangement, where cut surfaces of the tread thickness on opposing sides of the sipe are in contact or in an abutting arrangement to define the substantially zero thickness of the sipe. In particular embodiments, it is understood that “substantially equal to zero” ranges from zero (0) to 0.2 mm, or, in other embodiments, from zero to 0.1 mm. Further, it is to be appreciated that, while the sipe described above may have a zero width or thickness at a moment of formation such that it appears closed, thermal expansion and/or contraction effects can result in a slight opening such that the opposing sides are no longer in full contact. Nonetheless, such a sipe is a zero-thickness sipe since, at the moment of formation, the opposing sides will be in contact since no material is removed.

In addition, such a sipe is a zero-thickness sipe even though the sipe may also open as the tire rolls through a contact patch during tire operation, where in the open arrangement the cut surfaces on opposing sides of the sipe are at least partially separated such that the sipe opens to a width or thickness greater than zero. The tire contact patch is the portion of the tread contacting a ground surface at any time during tire operation. In general, the sipe is closed in the contact patch. In instances where the tire operates under driving or braking torque, the sipe may open when located in a leading or trailing edge of the contact patch. In addition, as the sipe may open as it rolls through areas just before and/or just after the contact patch.

In contrast to a sipe as described above, a groove generally has perceptible width or opposing sides which are not in contact. It is also noted that an arrangement of grooves generally define a tread element, such as a rib or a lug. A rib is defined as a portion of ground-engaging surface arranged between spaced-apart longitudinal grooves or a longitudinal groove and one of opposing sides of the tread defining the width of the tread, extending substantially the full length of the tread. That is, the rib extends substantially continuously around the circumference of the tire. If a rib is discontinuous, for example, due to the presence of one or more lateral grooves extending fully across a rib, the separated portions of the rib are referred to as lugs or blocks. More generally, a portion of the ground-engaging surface defined by a pair of spaced-apart longitudinal grooves, or a longitudinal groove and one of the lateral sides of the tread width, and a pair of spaced-apart lateral grooves is known as a tread lug or block. The rib can be a shoulder rib located at a lateral side of the tread width (which may be adjacent to the sidewall when installed on a tire) or a center rib located between a pair of spaced-apart longitudinal grooves.

In further embodiments, the method includes a step of demolding the tire tread from the mold. In doing so, the knife edge of the sipe-forming element lacerates a thickness of the cured molded tread as the sipe-forming element is pulled in a direction toward the outermost molding surface, which may be, for example, a radially outward direction when the tread is arranged in an annular arrangement. The resultant sipe includes a length extending in a direction transverse to the tread thickness. Further, it is noted that, in particular embodiments, when tread material is not removed by the action of lacerating the tread thickness by the knife edge, the sipe has a substantially zero thickness or width extending transverse to the sipe length and by a depth into the cured molded tread thickness from the ground-engaging side of the cured molded tread. As noted above, in particular embodiments, it is understood that “substantially equal to zero” ranges from zero (0) to 0.2 mm, or, in other embodiments from 0 to 0.1 mm. It is appreciated that the length of the sipe may extend fully across a tread element, or partially across a tread element, such as when the sipe extends from a groove or other void on a first side of the tread element and terminates within the length or width of a tread element inward a second, opposing side of the tread element. Such a tread element may be a shoulder rib or shoulder tread block. It is also appreciated that in partially extending across a tread element, the sipe may be fully arranged inward of both first and second opposing sides of the tread element length or width. Accordingly, the length of the sipe can extend across substantially any portion of the tread element without intersecting any grooves, intersecting only one groove, or intersecting two grooves.

It is also appreciated that the sipe-forming element can assume various cross-sectional shapes, such as when the sipe-forming element forms more than a zero-thickness sipe. For example, in particular embodiments, the sipe-forming element includes a submerged void-forming portion extending from the knife edge. In the step of molding, the submerged void-forming portion forms a submerged void, such as a groove or traditional sipe, spaced below the ground-engaging surface and arranged below and in communication with the zero-thickness sipe within the thickness of the cured molded tread. Accordingly, the sipe, having a substantially zero width, extends into the thickness of the tread and to the submerged void having a non-zero width. The submerged void-forming portion has a width for forming a thickness or width of the void in which it forms, the width extending is in a direction transverse to the length and a height of the submerged void-forming portion and sipe-forming element. The width of the submerged void-forming portion can be constant over a depth extending in a direction of the tread thickness. For example, the width can be substantially greater than the width or thickness of a sipe, and up to 10.0 mm or more. However, the submerged void-forming portion can have a width less than 0.2 mm provided the width is sufficient to support the knife edge given a material utilized for the tire. In an exemplary embodiment, the submerged void-forming portion is of variable width over its depth. For instance, the submerged void-forming portion can have a teardrop-shaped cross section where a maximum width is at a depth farthest from the outermost molding surface of the mold or the ground-engaging side in terms of the submerged void formed in the tread thickness by such submerged void-forming element. The width generally decreases with depth upwards towards the ground-engaging side of the tread to a minimum width at a bottom of the sipe. The width can decrease linearly or non-linearly and, moreover, the depth corresponding to the maximum width is not limited to the depth farthest from the ground-engaging side of the tread. Just as the width remains constant or vary as described above, so may the height of the submerged void or submerged void-forming element.

Particular embodiments of the tires and methods discussed above will now be described in further detail below in association with the figures filed herewith exemplifying the performance of the methods in association with particular embodiments of the tires.

With reference to FIG. 1, a molded tire 10 according to an exemplary embodiment of the present invention is shown. The tire 10 includes a pair of sidewalls 12 each extending radially outward from a rotational axis of the tire to a central portion 14 of the tire 10. The central portion 14 of the tire extends annularly and includes a tread 20 having a thickness T₂₀ extending in a radial direction from a ground-engaging side 22 of the tread to a bottom side 24 for attachment and bonding to the tire. The tread also has a width W₂₀ extending in a lateral direction between the pair of opposing, lateral sides or side edges 21 of the tread arranged adjacent sidewalls 12. The tread also includes a pair of shoulders arranged along each side 21 extending along the tread thickness T₂₀.

With regard to the ground-engaging side 22 of the tread 20, it is shown to include a plurality of voids 26 comprising longitudinal grooves having a length extending in a direction of the tread length, which is in a circumferential direction of the tire. Each void 26 comprising a longitudinal groove also has a depth d₂₆ extending into the tread thickness T₂₀ from the ground-engaging side 22. The longitudinal grooves 26 define a plurality of tread elements comprising ribs also extending in a direction of the tread length. The plurality of ribs include both shoulder ribs 28_{S} bounded by a lateral side 21 of the tread width W₂₀ and a longitudinal groove 26 and center ribs 28_{C} bounded on both sides by a pair of spaced apart longitudinal grooves 26. Center ribs 28_{C} are arranged intermediately between shoulder ribs 28S. While FIG. 1 illustrates a 4-rib tire, it is to be appreciated that the methods described herein can be utilized with tires having more or less ribs than tire 10.

According to the exemplary embodiment shown in FIG. 1, the tread 20 includes a plurality of sipes 30 comprising a laceration formed during a demolding operation, the sipe. In particular embodiments, the sipe has a thickness substantially equal to zero. Each sipe 30 extends into the tread thickness from the ground-engaging side 22 by a depth d₃₀. It is appreciated that the depth of each sipe 30 may extend into the thickness of the tread 20 by a depth equal to, less than, or greater than the depth of any groove 26. Each sipe 30 also has a length L₃₀ extending transversely to the tread thickness and the sipe depth. Certain sipes 30 are shown to have a length L₃₀ extending fully across a tread element (which comprises a rib in the embodiment shown) from a first a groove 26 to a second groove 26 or to a lateral side 21 of the tread width W₂₀, while other sipes 30 are shown to have a length L₃₀ extending partial across a tread element from a first a groove 26 and spaced apart from a second groove 26. Though shown in FIG. 1 as being aligned or co-linear, it is to be appreciated that sipes 30 can be otherwise arranged.

In the embodiment shown in FIG. 1, the sipes 30 arranged along the center ribs 28_{C} have lengths L₃₀ extending along non-linear, undulating paths. While FIG. 1 depicts sipes in the shoulder tread elements having lengths extending along linear paths, it is appreciated that the length of such sipes can extend along non-linear, undulating paths. It is noted that one or more apertures 34 may be arranged in communication with a sipe, where each aperture 34 extends into the tread thickness from a ground-engaging side or surface 22. Each aperture 34 is formed by a support member when a support member is used to assist in supporting a sipe-forming element used to form a sipe. Each aperture 34 generally has a width greater than the width of each sipe 30, and therefore has a width greater than zero or substantially zero.

In particular embodiments, such in the embodiment shown, each sipe 30 extends toward the ground-engaging side 22 from a submerged void 32 offset or spaced below the ground-engaging side within the tread thickness. In other words, each sipe 30 extends into the thickness of the tread 20 from the ground-engaging side and into a submerged void 32. In the embodiment shown, the submerged void 32 is a submerged groove, and more specifically a submerged lateral groove. As discussed above, the submerged void 32 may comprise any cross-sectional shape. Each submerged void 32 has a width that is wider than the width or thickness of the sipe 30, which is substantially zero. While the submerged void may comprise any desired void, in other embodiments, in lieu of a groove, the submerged void is a submerged traditional sipe having a thickness substantially greater than zero. Regardless, in any event, any submerged void 32 has a length extending in a direction transverse to the tread thickness and the width or thickness of the submerged void. The length of the submerged void may extend in a linear path or a non-linear path, regardless of whether the sipe length extends along the same or different path, or in a linear or non-linear path, where the non-linear path may be any non-linear path as contemplated above with regard to the sipe or sipe-forming element. It is appreciated that by forming a zero-thickness sipe, the stiffness of the tread element and therefore the tread increases relative to using traditional sipe having a thickness substantially greater than zero. It is also appreciated that having a length of the sipe-forming element extend along a non-linear path, the rigidity of the tread element and the tread increases.

As discussed above in association with various methods, a zero-thickness sipe is formed by way of molding and demolding operations. In an exemplary embodiment in FIGS. 2-4, a zero-thickness sipe 30 is formed in a tread 20 using a mold 40. Specifically, in FIGS. 2 and 3, a portion of a tread 20 as a portion of tire 10 formed in mold 40, which includes an outermost molding side or surface 42 from which groove-forming elements 44 extend into a molding cavity. The groove-forming elements 44 are configured to form longitudinal grooves, such as the grooves 26 of FIG. 1, although in other embodiments the groove-forming elements are used to form lateral grooves. The groove-forming elements 44 are also shown to extend into the molding cavity by a distance less than the tread thickness T₂₀, but may extend fully through the tread thickness in other embodiments. In lieu of using groove-forming elements, void-forming elements may be employed, such as to form any desired void, such as a groove or traditional sipe, for example.

In the embodiment shown, the mold further includes a sipe-forming element 46 configured to form a zero-thickness sipe in tread 20, such as sipe 30 of FIG. 1. The sipe-forming element 46 includes a knife edge 48 for lacerating a thickness of the tread as the sipe-forming element is removed from the tread by pulling the element outwardly from the tread thickness. To achieve its intended purpose, the sipe-forming element 46 and the knife edge 48 is spaced a distance d₄₆ from the outermost surface or outer side 42 of the mold. By doing so, an area or gap define by distance d₄₆ is formed between the outermost molding surface 42 and the sipe-forming element 46 for receiving tread material. During the molding operation, tread material is arranged in the area between the outermost surface 42 and the sipe-forming element 46. Once the tire tread 20 is cured, the tread is demolded from mold 40. During removal, the sipe-forming element 46 is drawn outwardly through the tread thickness defined by distance d₄₆. As exemplarily shown in FIG. 4, after the sipe-forming element 46 has been pulled outwardly from the tread thickness in a direction towards the outermost surface 42 or the ground-engaging side of the tread, the knife edge lacerates a thickness of the tread to form a sipe comprising a laceration. It is appreciated that, in particular embodiments where the tread is molded separately from the tire, such as when forming an annular tread for retreading operations, the sipe-forming element may be arranged below the tread thickness, so that the knife edge is pulled through the entire thickness of the tread to form a full-depth zero-thickness sipe.

As discussed above, the sipe-forming element may optionally include a submerged void-forming portion extending from the knife edge in a direction away from the outermost molding surface or outer side of the molding cavity. In an exemplary embodiment shown in FIG. 2, the sipe-forming element 46 includes a submerged void-forming portion 50 comprising a submerged groove-forming portion configured to form a submerged lateral groove within the tread thickness. As contemplated above, the submerged void-forming portion may form any desired void having any desired cross-sectional shape, and has a length that extends in a direction generally transverse to the height and width of the sipe-forming element and of the groove-forming portion.

In FIG. 5, the sipe-forming element 46 of FIGS. 2-4 is shown in further detail. In particular, the sipe-forming element 46 includes a length L extending in a direction transverse to the height H and width W of the sipe-forming element 46. Sipe-forming element 46 has a knife edge 48 and a submerged void-forming portion 50. It is appreciated that while both the knife edge 48 and the submerged void-forming portion 50 extend lengthwise along the sipe-forming element 46 along a common path, it is appreciated that the knife edge 48 and the void-forming portion 50 may have lengths extending along different paths as contemplated above. In the embodiment shown, the knife edge 48 has a length L₄₈ extending along a linear path (i.e., the knife edge is a linear knife edge). It is also noted that in the embodiment shown, the cross-sectional shape of the void-forming portion 50 and ultimately of the sipe-forming element 46 generally forms a teardrop-like shape, where the width W is at a maximum at an end opposite the knife edge 48 and decreases to a minimum width at the knife edge 48. FIG. 6 illustrates an alternative embodiment for the sipe-forming element 46 in which the knife edge 48 has a length L₄₈ extending along a non-linear path forming an undulating path. Moreover, as illustrated in FIG. 12A, the sipe-forming element 46 can include a serrated or jagged edge 54 in accordance with an alternative example.

In another exemplary embodiment shown in of FIG. 7, a sipe-forming element 146 is shown also having a length L extending in a direction transverse to the height H and width W of the sipe-forming element 146 and a submerged void-forming portion 150 extending from a knife edge 148. The void-forming portion has a slender cross-section configured to form a traditional or conventional sipe having a width greater than zero. As a result, in the tread formed using the sipe-forming element, a zero-thickness sipe is formed extending from a traditional sipe. In the embodiment shown, the knife edge 148 has a length L₁₄₈ extending along a linear path (i.e., the knife edge is a linear knife edge). FIG. 8 illustrates an alternative embodiment for the sipe-forming element 146 in which the knife edge 148 has a length L₁₄₈ extending along a non-linear path forming an undulating path. Moreover, as illustrated in FIG. 12B, the sipe-forming element 146 can include a serrated or jagged edge 154 in accordance with an alternative example.

As discussed above, the sipe-forming element may be attached to the mold in any desired manner. For example, in the embodiment shown in FIG. 2, the sipe-forming element 46 is operably attached to spaced apart first and second groove-forming elements 44 to maintain the sipe-forming element in a spaced arrangement relative to the outermost molding surface 42. In particular, each opposing terminal ends of the sipe-forming element 46 are attached to one of the pair of spaced apart groove-forming elements 44. In the arrangement shown, the sipe-forming element 46 is configured to form a sipe that extends fully across the tread element defined by opposing grooves formed by groove-forming elements 44. It is noted that in the embodiment shown, the sipe-forming element 46 is formed separate from the groove-forming element 44, whereby the sipe-forming element is removably or permanently attached to the groove-forming element.

In another embodiment, with reference to FIG. 9, a sipe-forming element 46 cantilevers from a first groove-forming element 44, such that the sipe-forming element is configured to form a sipe arranged between first and second grooves formed by first and second groove-forming elements, whereby the sipe extends from the first groove-forming element and partially across a tread element defined by the first and second grooves. The sipe-forming element 46 is supported at a first end by the first groove-forming element 44, and is additionally maintained in its arrangement by an optional support member 52, which extends between the sipe-forming element and the outermost surface 42 of the mold. It is noted that the support 52 forms the aperture 34 along the ground-engaging side of the tread as described above in association with FIG. 1.

In another embodiment shown in FIGS. 10 and 11, a sipe-forming element 46 is configured to form a sipe bounded within a width or length of a tread element such that the sipe does not intersect any groove or side of the tread element. In particular, the sipe-forming element 46 is maintained in a desired arrangement solely by using one or more support members, spaced apart from any adjacent groove-forming element 44, unlike the sipe-forming elements 46 described in FIGS. 1 and 9. In other words, the sipe-forming element 46 is anchored to the outermost molding surface, between groove-forming elements 44, by one or more support members 52. By doing so, a sipe formed by the sipe-forming element 46 with an aperture for each of the support members employed.

In accordance with certain finite element simulations conducted, benefits of zero-thickness sipes, as generally described herein, are exemplified in the chart shown in FIG. 13A in cooperation with various parameters identified in FIG. 13B. In FIG. 13A, the chart shown generally illustrates a percentage increase in rigidity for zero-thickness sipes over standard sipes, for different changes in the parameters describing the arrangement of a sipe extending to a ground-engaging side of the tread from a submerged void arranged within the tread thickness. This increase in rigidity (also referred to as “transverse rigidity”) occurs in a direction transverse to the direction of the tread thickness and transverse to a direction of the sipe length. For example, if a length of the sipe extends in a direction of the tread width, the transverse rigidity comprises longitudinal rigidity. By further example, if a length of the sipe extends in a direction of the tread length, the transverse rigidity comprises lateral rigidity.

With particular reference to FIG. 13B, various parameters are shown describing the height and depth of a sipe arranged in conjunction with a submerged void within a tread thickness, where a tire tread thickness T₂₀ is shown to include a submerged void X (i.e., submerged void 32) extending into the tread thickness by a depth Z₂ and a sipe S extending into the tread thickness by a depth Z₃ of from the submerged void. It is appreciated that for the evaluation, sipe S either comprised a zero-thickness sipe 30 or a standard sipe having a thickness of approximately 0.4 mm. With regard to depth Z₃, it can be said that depth Z₃ represents, in certain embodiments, knife edge length L₄₈ as discussed elsewhere herein. Finally, depth Z₁ represents the sum of depth Z₂ and depth Z₃. In particular embodiments, total depth Z₁ is equal to substantially 3 to 14 mm, although other depths may be employed in other embodiments. For example, it is appreciated that the total depth Z₁ may comprise a larger range, such as substantially 2 to 15 mm, or a sub-range, such as 5 to 10 mm.

In addition, the total depth Z₁ can be described as a function of total tread thickness T₂₀. For example, in particular embodiments, the total depth Z₁ is substantially equal to 50 to 90% of the total tread thickness T₂₀. Accordingly, by virtue of being described as a function of the total tread thickness T₂₀, the total depth Z₁ can be proportionally employed by any type of tire tread having any total tread thickness T₂₀. For example, such treads may be employed by high-performance tire or a light truck tire. In particular embodiments of such examples, Z₁ is at least equal to 26 to 86% of the tread thickness T₂₀, but less than the tread thickness, such that the submerged void is arranged within the tread thickness offset a distance from the bottom side of the tread.

With reference now to the depth or height of the submerged void, which is represented as Z₂ in FIG. 13B, in particular embodiments the submerged void height Z₂ is substantially equal to at least 2 mm and up to substantially 70% of the total depth Z₁, taken in the direction of the tread thickness. It is appreciated that Z₂ may be equal to less than 2 mm if achieving sufficient sipe robustness and greater than 70% of Z₁ if achieving further increasing or maintaining the rigidity of the tread. As mentioned above with regard to Z₁, the height Z₂ can also be described as a function of total tread thickness T₂₀.

With regard now to the length of the sipe extending from the submerged void, which is represented as Z₃ in FIG. 13B, in particular embodiments the distance from which the sipe extends upwards towards the ground-engaging side of the tread from the submerged void is substantially equal to at least 10% of the total depth Z₁ and up to the total depth Z₁ less 2 mm (that is, up to Z₁−2 mm). In other words, the depth Z₃ of the sipe can be a function of the total depth Z₁ and the height Z₂ of the submerged void, as shown in FIG. 13B. As mentioned above with regard to Z₁ and Z₂, the height Z₃ can also be described as a function of total tread thickness T₂₀.

As mentioned above, any two of the three parameters described can be utilized to derive the third. It is appreciated, however, that alternative dimensions can be employed in connection with the methods described herein and the attached claims are not limited to the specific parameters described above.

With regard now to the chart shown in FIG. 13A, a comparison of simulation results between tread blocks having zero-thickness sipes as generally described above and tread blocks having standard sipes having a thickness of approximately 0.4 mm, for different heights Z₂ of the submerged void (expressed as a percentage of total depth Z₁). For each of the zero-thickness and standard sipes, each sipe was a straight sipe extending into the tread thickness along a straight path. For these simulations, the tire tread thickness T₂₀ is 8.5 mm and the total depth Z₁ is 8 mm. The simulations were performed using finite element analysis (FEA) on a 2-dimensional tread model generally shown in FIG. 13B, where the bottom side of the tread was fixed (that is, constrained in all directions) while a lateral shearing load was applied to the ground-engaging side by way of imposing a lateral displacement on the tread. Upon review of the results, which are reflected in FIG. 13A, an increase in transverse rigidity is realized in all tread blocks having zero-thickness sipes as compared to tread blocks having standard sipes when the height Z₂ is less than 90% of the total depth Z₁. With a height Z₂ equal to 70% or less of the total depth Z₁, at least a 5% increase in transverse rigidity is realized for the values of total tread thickness T₂₀ and total depth Z₁ utilized for the tests. In instances when Z₂ is equal to 50% of the total depth Z₁, a straight sipe provides approximately an 11% transverse increase in rigidity. Finally, in instances when Z₂ is equal to approximately 35% of the total depth Z₁, a straight sipe provides approximately a 16% increase in transverse rigidity. More generally, it is observed that an overall increase in transverse rigidity is obtained when the % value of Z₂ decreases when using zero-thickness sipes as compared to the use of straight sipes.

Based upon these results, in view of the broader invention, because the substantially zero-thickness sipes may extend lengthwise in any direction of the tire or tire tread, it can be said that increases in transverse rigidity are realized in a direction transverse to the length of the sipe. Therefore, when employing substantially zero-thickness sipes as described herein, an increase in transverse rigidity is obtained in any direction of the tire or tire tread transverse to both the tread thickness and the length of the sipe, which may comprise a longitudinal or lateral direction of the tire or tire tread, or any direction there between. It is noted that the simulations evaluate the benefit of employing substantially zero-thickness sipes without considering any benefits associated with the length of the sipe extending along a non-linear path.

It is appreciated that formation of zero-thickness sipes on the outer side of the tread may be performed by any manual or automated process or machine, of which may contain a processor and memory storage device configured to store instructions for performing the method steps discussed and contemplated herein.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the invention. Ranges that are described as being “between a and b” are inclusive of the values for “a” and “b” unless otherwise specified.

While this invention has been described with reference to particular embodiments thereof, it shall be understood that such description is by way of illustration only and should not be construed as limiting the scope of the claimed invention. Accordingly, the scope and content of the invention are to be defined only by the terms of the following claims. Furthermore, it is understood that the features of any specific embodiment discussed herein may be combined with one or more features of any one or more embodiments otherwise discussed or contemplated herein unless otherwise stated.

1. A method of forming a tire, the method comprising:
providing a mold configured to mold a tire tread, the mold having an outermost molding surface configured to form a ground-engaging side of the tire tread and a sipe-forming element spaced apart inwardly from the outermost molding surface and having a knife edge oriented towards the outermost molding surface and a submerged void-forming portion extending from the knife edge, the sipe-forming element having a length extending in a direction transverse to a tread thickness;
arranging an uncured tire tread within the mold, the tire tread having a thickness extending depthwise into a molding cavity from the outermost molding surface such that a portion of the tire tread is arranged between the outermost molding surface and the sipe-forming element;
molding the tire tread arranged within the mold to form a cured molded tread having a thickness extending from a ground-engaging side of the cured molded tread; and
demolding the tire tread from the mold such that the sipe-forming element forms a sipe by the knife edge lacerating a thickness of the cured molded tread as the sipe-forming element is pulled in a direction toward the outermost molding surface and forms a submerged void spaced below the ground-engaging side and arranged below the sipe within the thickness of the cured molded tread, the sipe having a length extending in a direction transverse to the tread thickness.

2. The method of claim 1, where the mold further includes a groove-forming element extending inward from the outermost molding surface, such that in the step of molding, the groove-forming element forms a groove in the cured molded tread, the groove extending into the thickness of the cured molded tread from the ground-engaging side.

3. The method of claim 2, where the sipe-forming element is operably attached to the groove-forming element, such that in the step of demolding, the sipe formed extends from the groove formed by the groove-forming element.

4. The method of claim 2, where the sipe-forming element is spaced apart from the groove-forming element, such that in the step of demolding, the sipe formed is spaced apart from the groove formed by the groove-forming element.

5. The method of claim 4, where the sipe-forming element is spaced apart from, and arranged between, both the groove-forming element and a second groove-forming element, whereby in the step of demolding, the sipe formed is spaced apart and arranged between the groove formed by the groove-forming element and a second groove formed by the second groove-forming element.

6. The method of claim 2, where the sipe-forming element is rigidly maintained in a desired position by a support element extending from the outermost molding surface.

7. The method of claim 4, where the sipe-forming element is rigidly maintained in a desired position by a plurality of support elements extending from the outermost molding surface.

8. The method of claim 2, where the sipe-forming element cantilevers from the groove-forming element.

9. The method of claim 1, where the knife edge is a serrated edge.

10. The method of claim 1, where the submerged void-forming portion has a teardrop-shaped cross-section, such that the submerged void formed has a teardrop-shaped cross-section.

11. The method of claim 1, where the sipe formed extends from the ground-engaging side of the tire tread to the submerged void.

12. The method of claim 1, where the length of the sipe-forming element extends along a non-linear path, such that in the step of demolding, the sipe-forming element forms the sipe with the length extending along the non-linear path.

13. The method of claim 1, where the tire tread is bonded to a tire in the step of molding.

14. A molded tire, comprising:
a pair of sidewalls extending radially outward to a central portion of the tire, the pair of sidewalls being spaced apart in an axial direction of the tire;
a tire tread extending between the pair of sidewalls, the tire tread having a thickness extending from a ground-engaging side to a bottom side interfacing the central portion of the tire;
a sipe comprising a laceration formed during a demolding operation, the sipe having a length extending in a direction transverse to the tread thickness and having a thickness extending transverse to the length and into a depth of the tread thickness from the ground-engaging side; and
a submerged void spaced below the ground-engaging side and arranged below the sipe within the thickness of the tire tread.

15. The tire of claim 14, where the sipe thickness is substantially equal to zero.

16. The tire of claim 14, where the sipe thickness is equal to or less than 0.2 mm.

17. The tire of claim 14, the tire tread further including a groove extending into the tread thickness from the ground-engaging side, where the sipe extends from the groove along a non-linear path in a direction substantially transverse to a length of the groove.

18. The tire of claim 14, the tire tread further including a groove extending into the tread thickness from the ground-engaging side, where the sipe is spaced apart in the tire tread from the groove and where the sipe is spaced apart and arranged between the groove and a second groove extending into the thickness of the tire tread from the ground-engaging side.

19. The tire of claim 17, where the tire tread includes an aperture extending into the tread thickness in connection with the sipe, the aperture having a width greater than the sipe.

20. The tire of claim 14, where the length of the sipe extends along a non-linear path.

21. (canceled)
